(19) United States
(12) Patent Application Publication
(10) Pub. No.: US 2024/0198439 A1
(43) Pub. Date: Jun. 20, 2024

(54) PIPE SAW HAVING TORSIONAL VIBRATION DAMPING MEANS

(71) Applicant: RATTUNDE AG, Ludwigslust (DE)

(72) Inventor: Ulrich RATTUNDE, Ludwigslust (DE)

(73) Assignee: RATTUNDE AG, Ludwigslust (DE)

(21) Appl. No.: 18/555,397

(22) PCT Filed: Jan. 10, 2023
(86) PCT No.: PCT/EP2023/050384

§ 371 Date: Oct. 13, 2023

(30) Foreign Application Priority Data
Jan. 17, 2022 (DE) 20 2022 100 236.3

(51) Int. Cl. B23D 47/00; B23D 45/12

(52) U.S. Cl. CPC B23D 47/005; B23D 45/12

(57) ABSTRACT

The invention relates to a sawing machine with a saw shaft (2) on which a saw blade (3) is mounted, characterised by torsional vibration damping with a damping mass (7) which is arranged next to the saw blade (3) on the saw shaft (2) and completely surrounds the saw shaft (2) in a cross-section, and the damping mass (7) is separated from the saw shaft (2) by a gap (11) and arranged with a clearance on the saw shaft (2), and the gap (11) between the damping mass (7) and the saw shaft (2) is filled with a fluid.

The invention relates to a sawing machine with a saw shaft on which a saw blade is mounted.

Sawing machines are known in the prior art. For example, a tube sawing machine is known from DE 10 2004 053 732 B3, with which sections of a tube can be cut to length. Tube sawing machines are often part of an integrated sawing plant in which the tubes are not only cut to length, but also washed, chamfered and otherwise processed.

The high precision requirements for the cut-to-length tube sections and the service life of the saw blades are still problematic. For example, metal tubes should be cut to length with an accuracy of 0.01 mm, and this accuracy should be maintained with a probability of 99.99%.

Torsional vibrations have turned out to be a particular problem, which are caused by the fact that the load acting on the saw blade is not constant, but is subject to periodic fluctuations due to saw tooth entry and exit into the material of the tube. These lead to an undesirable torsional vibration of the saw shaft and in the saw blade.

It is therefore an object of the present invention to provide a sawing machine which reduces the above disadvantage.

The object is fulfilled by a sawing machine mentioned at the beginning with the features of claim 1. The sawing machine according to the invention has a saw shaft on which a saw blade is mounted. According to the invention, torsional vibration damping is provided with a damping mass which is arranged next to the saw blade on the saw shaft and completely surrounds the saw shaft in a cross section, and the damping mass is separated from the saw shaft by a gap, the damping mass having a clearance on the saw shaft and the gap between the damping mass and the saw shaft being filled with a fluid.

The damping mass preferably runs completely around the saw shaft along a section of the saw shaft in each cross-section. The damping mass is preferably placed on the saw shaft with a clearance in each cross-sectional direction. Preferably, the gap has a width of 0.01 mm+/−0.005 mm, whereby the clearance preferably assumes the same numerical size. However, other numerical ranges are also conceivable.

Because the damping mass is fitted onto the saw shaft with a clearance and the gap is filled with a preferably viscous fluid, the damping mass produces a damping effect on the saw shaft, i.e. the damping mass counteracts changes in the angular velocity of the saw shaft. If the saw shaft increases its angular velocity slightly, the damping mass follows the change slightly and brakes the saw shaft through the fluid. Conversely, the advancing damping mass accelerates the saw shaft when the saw shaft's angular velocity is reduced.

Preferably, the saw blade is mounted on one end of the saw shaft, and a drive gear wheel, which is connected to the saw shaft in a rotationally fixed manner along the saw shaft, is arranged between the damping mass and the saw blade.

The saw shaft and thus also the saw blade are driven via the drive gear wheel. The saw blade is used to cut profiles to length or something similar, preferably metal tubes, metal profiles.

In a favourable embodiment of the invention, a surface of the saw shaft is cylindrical along a longitudinal portion in which the damping mass is arranged, and an inner wall of a bore of the damping mass is also cylindrical. This means that an outer wall of the saw shaft and an inner wall of the damping mass are formed as two cylinders arranged concentrically towards each other. The gap is formed by a circumferential ring which can be filled with the fluid. The damping effect in this case comes about through a Newtonian frictional force. The damping mass is preferably completely rotatable around the saw shaft.

However, other cross-sectional shapes of the gap are also possible. Preferably, the surface of the saw shaft has a profile in a longitudinal section in which the damping mass is arranged, and an inner wall of a bore of the damping mass has a corresponding profile. The profile may, for example, be a meander profile, and the corresponding profile may be a corresponding meander profile. As a result, the damping mass is no longer rotatably arranged on the saw shaft, but it still has play in each direction. In this case, the damping effect is less due to a Newtonian friction force and more due to the fact that the fluid arranged in the gap flows back and forth between the tooth flanks of the meander profile and thereby creates a suction or pressure effect on the teeth of the saw shaft that is opposite to the change in the angular velocity of the saw shaft.

Advantageously, the damping mass has radial bores for filling the gap with the fluid. The bores can be closed from the outside.

The invention is described by means of two embodiment examples in four figures:

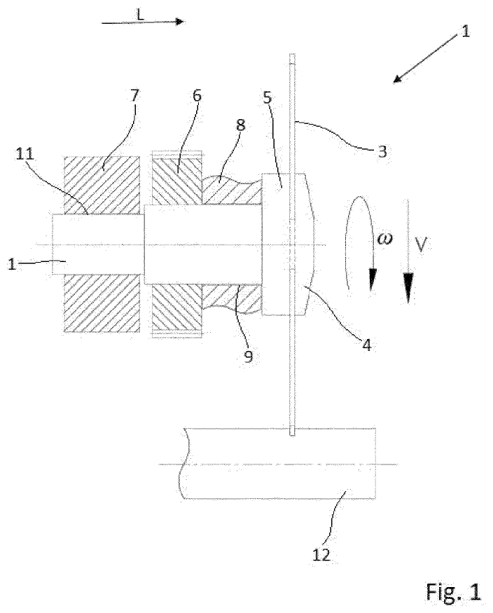

FIG. 1a longitudinal section of a part of a first embodiment of a damping mass of a sawing machine according to the invention

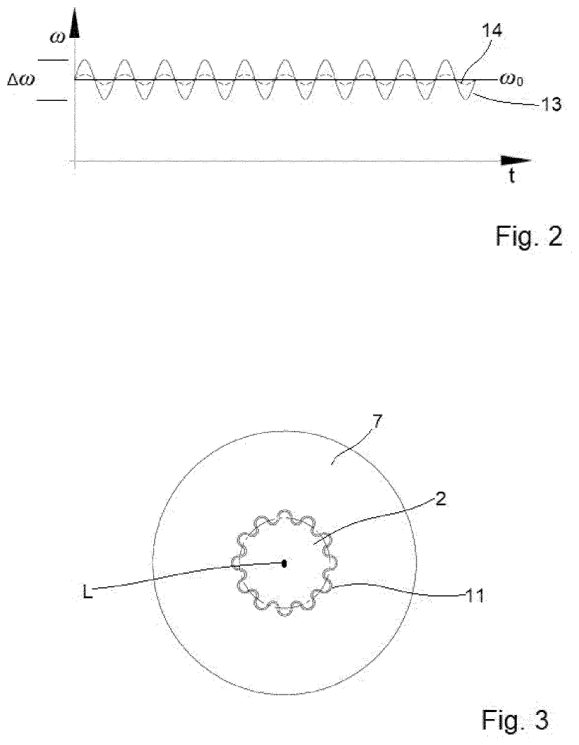

FIG. 2a graphical representation of the dependence of an angular velocity on time with and without damping

FIG. 3a cross-section of a second embodiment of a damping mass according to the invention

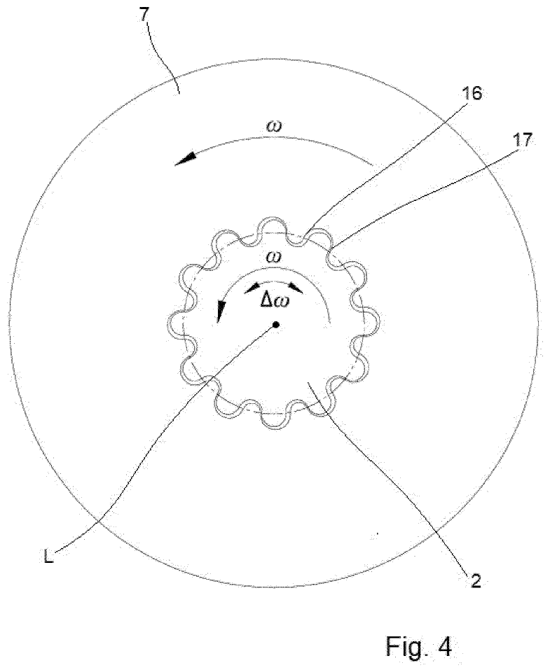

FIG. 4a cross-section of a second embodiment of the damping mass in operation

FIG. 1 shows a section of the sawing machine 1 according to the invention with a saw shaft 2, on one end of which a saw blade 3 of circular cross-section with a saw clamping cover 4 is mounted on a saw bearing 5. The saw shaft 2 is driven by a drive gear wheel 6 which is connected to the saw shaft 2 in a rotationally fixed manner. The drive of the drive gear wheel 6 itself is not shown. In addition to the drive gear wheel 6, a damping mass 7 is provided on the saw shaft 2. The damping mass 7 completely surrounds the saw shaft 2 along a section in cross-section. The drive gear wheel 6 is arranged between the damping mass 7 and the saw blade 3. A housing 8 runs between the drive gear wheel 6 and the saw bearing 5. The saw shaft 2 is mounted in a sliding bearing 9 in the housing 8.

There is a circumferential gap 11 between the damping mass 7 and the saw shaft 2, so that the damping mass 7 is arranged on the saw shaft 2 with a clearance that is 0.01 mm and +/−0.005 mm. The gap 11 is filled with a fluid. The fluid can be oil. For filling the gap 11, channels can be provided through the damping mass 7, which allow the gap 11 to be filled from the outside.

The gap 11 is annular in cross-section in the first embodiment shown in FIG. 1 perpendicular to a longitudinal direction L when the saw shaft 2 and damping mass 7 are positioned concentrically to each other. The gap 11 is formed along the entire extension in longitudinal direction L of the damping mass 7 surrounding the saw shaft 2. The damping mass 7 has a hollow cylindrical shape.

FIG. 1 shows the saw blade 3 cutting into a workpiece 12, for example a tube, which is to be cut to length.

FIG. 2 shows undamped oscillations of an angular velocity 13 and damped oscillations of an angular velocity 14 around a constant operating angular velocity ω0. The saw blade 2 has the operating angular velocity ω0 in operation. The torsional vibrations of the saw blade 3 are superimposed on the operating angular velocity ω0. The torsional vibrations are caused by the fact that tooth meshing and tooth exit alternate and the saw blade is thus periodically slowed down and accelerated slightly.

The damped oscillation of the angular velocity 14 in FIG. 2 shows the effect of the damping mass 7, which causes the amplitudes of the torsional oscillations to be significantly reduced compared to the undamped oscillation of the angular velocity 13. The damping mass 7 is arranged on the saw shaft 2 so that it can move in the circumferential direction. In FIG. 1 Newtonian friction between the damping mass 7 and the saw shaft 2 in accordance with

$${F}_{r} = A \cdot η \cdot ( dv : dy )$$

takes place when the angular velocity of the saw shaft 2 increases or decreases. Here A means the gap area, and n means the viscosity of the fluid, in this case the oil, and (dv:dy) means the change in velocity in the direction of rotation.

The inertia of the damping mass 7 leads to the fact that when the angular velocity ω of the saw shaft 2 decreases, the damping mass 7 runs forward and generates an additional force against the decreasing angular velocity ω, whereas in the case of increasing the angular velocity ω of the saw shaft 2 the exactly opposite effect occurs.

FIG. 3 shows in a cross-section a second embodiment of the gap 11 according to the invention between the damping mass 7 and the saw shaft 2. The gap 11 has a meandering shape in a cross-section. Whereas in the first embodiment there is Newtonian friction between the damping mass 7 and the saw shaft 2, in the case of the second embodiment the damping occurs because the damping mass 7, due to its inertia, runs behind the change in angular velocity and the torsional vibrations displace or suck the fluid out of sections of the gap 11. The cross-sectional shape in FIG. 3 is referred to here as a meander shape. Other cross-sectional shapes are also conceivable.

FIG. 4 shows the effect of the gap 11 in meander form in detail. The angular velocity ω of the saw shaft 2 is variable. The angular velocity ω decreases when a tooth enters and increases when a tooth exits the workpiece 12. The change in the angular velocity ω of the saw shaft 2 is Δω.

If a slight change in angular velocity Δω occurs, in which case the saw blade 3 and thus the saw shaft 2 are slowed down slightly by a tooth entry, the damping mass 7 runs forward in the direction of rotation, in FIG. 4 counterclockwise, and shifts clockwise relative to the saw shaft 2. Gap enlargements 16 and gap reductions 17 are produced. The gap enlargements 16 exert a suction effect on the fluid, and the gap reductions 17 displace the fluid. This gives the saw shaft 2 a small additional propulsion and the torsional vibration is damped.

### LIST OF REFERENCE SIGNS

1 Sawing machine
2 Saw shaft
3 Saw blade
4 Saw clamping cover
5 Saw bearing
6 Drive gear wheel
7 Damping mass
8 Housing
9 Sliding bearing
12 Workpiece
13 Undamped oscillation of the angular velocity
14 Damped oscillation of the angular velocity
16 Gap enlargement
17 Gap reduction
L Longitudinal direction
ω Angular velocity
ω0 Operating angular velocity
Δω Change in angular velocity

1. Sawing machine with a saw shaft (2) on which a saw blade (3) is mounted, characterised by torsional vibration damping with a damping mass (7) which is arranged next to the saw blade (3) on the saw shaft (2) and completely surrounds the saw shaft (2) in a cross-section, and the damping mass (7) is separated from the saw shaft (2) by a gap (11) and arranged with a clearance on the saw shaft (2), and the gap (11) between the damping mass (7) and the saw shaft (2) is filled with a fluid.

2. Sawing machine according to claim 1,
characterised in that the damping mass (7) is arranged with a clearance of 0.01 mm±0.005 mm in each cross-sectional direction on the saw shaft (2).

3. Sawing machine according to claim 1,
characterised in that the saw blade (3) is mounted on one end of the saw shaft (2) and a drive gear wheel (6), which is connected to the saw shaft (2) in a rotationally fixed manner, is arranged between the damping mass (7) and the saw blade (3).

4. Sawing machine according to claim 1,
characterised in that a surface of the saw shaft (2) in a longitudinal portion in which the damping mass (7) is arranged is cylindrical and an inner wall of a bore of the damping mass (7) is also cylindrical.

5. Sawing machine according to claim 1,
characterised in that the surface of the saw shaft (2) has a profile in a longitudinal section in which the damping mass (7) is arranged, and an inner wall of a bore of the damping mass (7) has a corresponding profile.

6. Sawing machine according to claim 5,
characterised in that the profile is a meander profile and the corresponding profile is a corresponding meander profile.

7. Sawing machine according to claim 1, characterised in that the damping mass (7) has radial bores for filling the gap (11) with the fluid.
